(19) United States
(12) Patent Application Publication
(10) Pub. No.: US 2010/0257781 A1
(43) Pub. Date: Oct. 14, 2010

(54) SOLAR-AUGMENTED, NOX- AND CO2-RECYCLING, POWER PLANT

(76) Inventors: J. Clair Batty, Logan, UT (US); Craig E. Cox, Fruit Heights, UT (US); David A. Bell, Farmington, UT (US)

Correspondence Address: PATE PIERCE & BAIRD, 175 SOUTH MAIN STREET, SUITE 1250, SALT LAKE CITY, UT, 84111, US

(21) Appl. No.: 12/759,207

(22) Filed: Apr. 13, 2010

Related U.S. Application Data
(60) Provisional application No. 61/169,270, filed on Apr. 14, 2009.

(51) Int. Cl. A01G 1/00; B01D 53/14; B01D 53/73; A47G 5/00

(52) U.S. Cl. 47/1.4; 95/235; 95/206

(57) ABSTRACT

Stack gases of a burner, such as a power plant or other combustion source, may be remediated by a captive algae farm cycling some portion of the stack gases through a scrubber, and ultimately out into a manifold feeding a farm composed of tubes hosting the growth of algae. Liquids from the scrubber, including water capturing volatile organic compounds, solid particulates, nitrogen compounds, sulfur compounds, carbon dioxide, and the like, remediate the water and feed the algae farm. Meanwhile, the vapors and other gases provide an environment rich in water vapor, nitrogen compounds acting as fertilizer, and carbon dioxide to feed the algae to promote increased rates of growth. The algae may be recycled as a fuel itself, or may be harvested for use as a soil amendment to enrich the organic content of soils.

### RELATED APPLICATIONS

This patent application claims the benefit of co-pending, U.S. Provisional Patent Application Ser. No.: 61/169,270, filed Apr. 14, 2009, and entitled SOLAR-AUGMENTED, CARBON-RECYCLING, POWER PLANT, which is incorporated herein by reference in its entirety, including the Appendix thereof. This application also incorporates by reference U.S. Provisional Patent Application Ser. No. 61/144,694, filed Jan. 14, 2009, and entitled BACK PRESSURE-MATCHED, INTEGRATED, ENVIRONMENTAL-REMEDIATION APPARATUS AND METHOD.

### BACKGROUND

1. The Field of the Invention

This invention deals with power plant combustion, and more particularly, with handling of effluents from the stacks thereof.

2. The Background Art

Man relies on energy at all levels of civilization. In the crudest shelter, a fire provides light, heat, and the chemical reactions associated with cooking. In its most complex and advanced forms, civilization relies on coal, natural gas, fossil fuels, and the like to fire power plants and industrial process plants.

It would be an advance in the art to improve handling of effluents from combustion in power plants. Whether a power plant is providing steam to run a turbine and generator or simply process heat for a factory, stack gases may include carbon dioxide, water vapor, unburned hydrocarbons (volatile organic compounds or VOCs), compounds of nitrogen, (most notably the various oxides of nitrogen, called NOx), and various other trace elements, compounds, and minerals. Some of those other minerals and elements include salts, metals, oxides of sulphur (e.g., as sulphur dioxide), and so forth. It would be an advance in the art to provide energy efficient collection, recycling, removal, and other handling processes for power plant stack effluents.

### BRIEF SUMMARY OF THE INVENTION

In view of the foregoing, in accordance with the invention as embodied and broadly described herein, a method and apparatus are disclosed in one embodiment of the present invention as including a combustor such as a furnace or power plant combustion chamber, having a stack for discharge of the products of combustion. Drawing from the stack is another conduit carrying a portion of the effluents (from 0-100%) into a scrubber section. The scrubber section may include curtains of water spray, cooling the products of combustion, scrubbing VOCs out of the flow, reacting out NOx, condensing certain compounds, capturing oxides of sulphur, rendering a useful, weak, sulfurous acid, capturing particulate matter and otherwise cleaning up the stack effluents. Ultimately, the liquids may be drained from the scrubber to hydrate an algae farm.

The algae farm is likewise fed the remaining, scrubbed stack gases comprising primarily oxygen, water vapor, nitrogen compounds, and carbon dioxide. This warm, enriched gas environment greatly enhances the photosynthesis processing of the plants. Plants consume the carbon for making the plant structures by photosynthesis, use the compounds of nitrogen as they would use conventional fertilizers in their processes, and meanwhile release oxygen back into the environment.

Meanwhile, the liquids, including primarily water, as well as volatile organic compounds, nitrogen compounds, weak sulfurous acid, and the like go to support the needs of algae growth. The algae may be grown in tubes forming miniature greenhouses.

For example, in one embodiment a large manifold carrying liquid flow in the bottom portion thereof and gas flows in the upper portion thereof delivers to a large array of replaceable, thin, plastic, film tubes a distribution of water and the overlying gases. The water sustains algae growth while the gases feed the carbon dioxide needs of the algae. Meanwhile, the moderated temperature supports year-around operation of the algae farm.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of an algae farm supporting a combustor, such as a power plant combustion chamber, by drawing off effluents thereof through a scrubber section driven by a blower, which blower delivers the effluent flow through a manifold to a farm of growing tubes, each tube laid in a furrow for support and containing water in the lower portion thereof below effluent gases in the upper portion thereof;

FIG. 2 is a cross-sectional, perspective view of an array of tubes from the apparatus of FIG. 1;

FIG. 3 is a top plan view of the algae farm recycling system of FIG. 1; and

FIG. 4 is a schematic block diagram of the process flows of fuels, effluents, and photosynthesis products of the apparatus of FIGS. 1-3 in operation.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

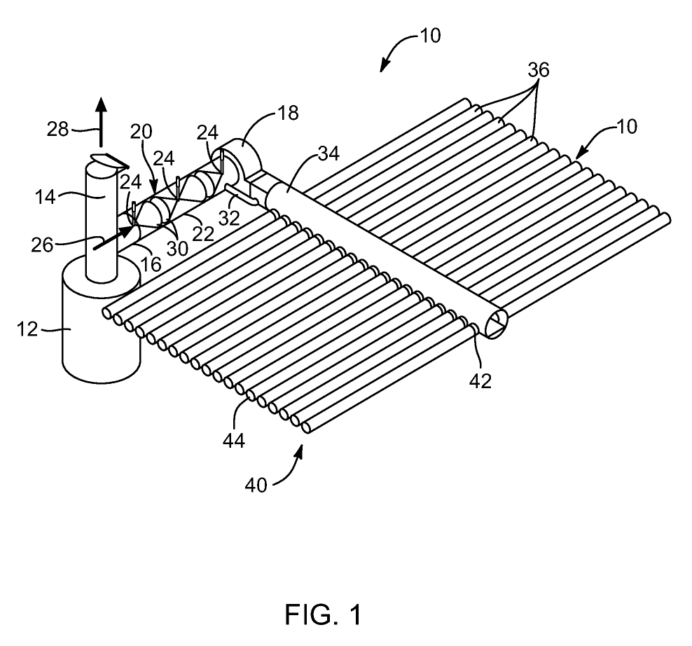

Referring to FIG. 1, while also referring generally to FIGS. 1-4, a system 10 in accordance with the invention may include a burner 12 or furnace 12. Typically, the burner 12 may be a part of a power plant. In alternative embodiments, any source of heat involving combustion may serve the function of the burner 12.

In certain embodiments for remediation of effluents from the stacks 14, fossil-fired electrical generating plants may serve as the burners 12, whether coal or liquid petroleum fired. Likewise, natural-gas-fired powerplants and the like all include burners 12. In the illustrated embodiment, all of the heat transfer mechanisms for extracting power from heat, by way of steam, electricity, or otherwise, are not illustrated. Such technology is known and is beyond the scope of the instant invention.

The burner 12 may be of a fluidized-bed type, or of any other type. Nevertheless, a fluidized bed has been found to be suitable for burning various types of fuel. Moreover, a fluuidized bed may be quite robust in handling mixed varieties of fuel that can be reasonably combined or alternated.

In certain embodiments, the burner 12 feeds exhaust into a stack 14 discharging the products of combustion. A diversion 16 may be taken off the stack 14. The diversion 16 may carry anywhere from zero to 100 percent of the stack effluents. The diversion 16 may carry any selected portion that may be suitably handled by a scrubber 20 and other apparatus and methods downstream in accordance with the invention.

In the illustrated embodiment, the diversion 16 is fed by the stack 14, motivated by a blower 18 drawing on the stack 14 through the conduit 22 of the scrubber 20 toward the blower 18. The conduit 22 encloses a variety of nozzles 24 spraying water into the conduit 22. Accordingly, the conduit 22 with the nozzles 24 forms the scrubber 20 that scrubs out various entrained constituents from the flow 26 diverted out of the discharge or flow 28 from the stack 14.

For example, volatile organic compounds (VOCs) may remain in the flows 26,28. Sometimes called unburned hydrocarbons, these constituents may be captured by the surface tension of water 30 in a curtain 30 or a spray 30 discharged by the nozzles 24. Having a plurality of nozzles 24, multiple embodiments of the curtain 30 may impinge on the flow 26, thus providing multiple opportunities for various condensible and particulate materials to be captured by the surface tension of the water in the sprays 30.

Likewise, compounds of nitrogen may be entrained, dissolved, and reacted in the water. These nitrogen oxides thus form nitrates or other nitrogen compositions useful as fertilizer to assist the algae growth. Thus, NOx is removed from the atmosphere and recycled to augment growth processes of plant materials. In certain embodiments, such nitrogen-enriched water may be released to assist in growth of crops other than algae.

The scrubber 20 and various embodiments for constructing it, implementing it, and augmenting it are disclosed in U.S. Provisional Patent Application No. 61/144,694 incorporated herein by reference. The detailed disclosure thereof will not be, therefore, repeated here.

Due to the heat energy content of the flow 26 diverted from the stack 14, a certain amount of the water 30 sprayed by the nozzles 24 will evaporate into the flow 26. Another portion of that water 30 will remain liquid, containing the trapped VOCs, particulate matter, absorbed or reacted gases such as NOx and CO2, and the like. Ultimately, the liquid portion of materials flowing through the scrubber 20 may be collected and discharged through a drain 32.

Meanwhile, the water vapor and other gaseous constituents in the flow 26 may pass through the blower 18 to be discharged into a manifold 34 or distributor 34. Also, the drain 32 may feed into the same or a different distributor 34 or manifold 34. In the illustrated embodiment, the manifold 34 may carry both liquid and vapors, such as non-condensibles or vapors. Typically, the liquid collects near the bottom portion of the manifold 34, while the gases remain thereabove in the manifold 34.

Connected to the distributor 34, numerous tubes 36 may be connected to form an array 38 constituting a farm 40 for production of algae. Each of the tubes 36 may be placed in a furrow in the earth. Thus, the liquid in each tube 36 may be supported by the earthen furrow therebelow, while the gases passing therethrough are captured by the closed upper surfaces of the tubes 36. Ultimately, the inlet end 42 of each tube 36 receives some amount or liquid and some amount of gas flowing through Likewise, the exit end 44 of each tube 36 may be restricted in order to provide the pressure differential effective for maintaining an atmosphere of gas above the algae growth in each tube 36.

For example, the tubes 36 may be laid out to extend substantially level. Unlike common irrigation, the fall or slope of land is not required for the tubes 36 growing algae. Rather, the difference in altitude between the inlet end 42 and outlet end 44 may be nothing. In fact, a simple barrier or rise in the earth may establish a dam or level over which each tube 36 may pass, thus maintaining a trench, horizontal column, or furrow of liquid within each tube 36.

Algae growth may be initiated and promoted within the liquid in the lower portion of each of the tubes 36. Each of the tubes 36 becomes a miniature greenhouse. Nevertheless, the humidity may be substantially 100 percent. This may exist in a wide variety of conditions. The upper surfaces of the tubes 36 may cool the water vapor in the tubes 36, condensing a certain amount of the water vapor.

In certain embodiments air may be blown through the tubes 36. Waves created on top of the water by the flow of air tend to enhance engagement between the water and the air. In certain embodiments, air may be valved to pulse a flow of air through a tube. Tubes may be connected to pass straight away from the central manifold 34 or may be connected in a “U” shape to initially exit and later return to the manifold 34. In such embodiments, slight rises under flexible tubes 36 may effectively create dams. Upon receiving a pulse of air, the water in a tube 36 sets up waves, further engaging the air, transferring momentum to the water, with a resulting flow of water in the direction of the pulsed air flow. The momentum of the water causes the water to move, rising over the dams, where it is trapped until another pulse repeats the process. A peristaltic pumping results.

Another advantage of this pulsed air circulation process occurs in the algae growing in the tubes 36. Boundary layer theory in fluid mechanics affects top and bottom surfaces of the water. The top surface tends to follow the motion of the air. The bottom surface tends to remain at rest with the fixed tube 36. The algae, driven in opposite directions by these motions tends to tumble, thus greatly increasing access to nutrients, air, dissolved gases, nitrogen compounds, and carbon dioxide. Increases in algae growth result.

In some embodiments, a selected amount of restriction to gas flow may be provided by folding, obstructing, constricting, or otherwise limiting escape of gas and liquid, thus promoting a slight pressure differential in each tube 36, between the exit end 44 thereof, and the blower 18. Thus, the gases driven by the blower 18 may maintain inflated each of the tubes 44.

The carbon dioxide content of the flow 26 vigorously promotes photosynthesis. The absorbed NOx with its resulting fertilization content in the water also greatly assists growth. The photosynthesis process, whereby plant organisms take in solar energy, captures solar energy in chemical bonds of carbon structures in the plant organism. Thus, the carbon dioxide from the flow 26 contributes carbon, the nitrogen compounds in the water provide required nutrients, the sun contributes energy, and the plant (algae in this case) provides the chemical process to absorb the solar energy and put it into carbon bonds forming the structure of the plant organism. Meanwhile, oxygen is released. Thus, the algae farm 40 not only consumes carbon dioxide and NOx but releases oxygen previously captured in both.

Some advantages of the arrangement illustrated include the consumption of carbon, remediating and recycling of NOx, scrubbing of VOCs from the flow 26 in the stack 14, provision of heat even in winter time in order to maintain year-around operation of the farm 40, and weather protection due to the extremely low profile of the tubes 36. For example, the tubes 36 are quite literally within the “nap of the earth.” They may be captured at virtually the lowest level of that nap of the earth, namely, in furrows formed in the earth.

The height of each furrow may be selected to optimize the proportion of the perimeter of each tube 36 exposed to the soil, and the proportion of that perimeter exposed to the atmosphere. The more of a tube 36 that is exposed to the atmosphere, and not to another tube or the earth, the more heat transfer is permitted into the air. By contrast, the closer proximity each tube has to another tube, and the deeper the furrow thereof, the less heat is transferred to the air.

Thus, furrows may be adjusted and the tubes 36 may be relaid or replaced for winter operation, wherein close proximities and minimum heat transfer may be preferred. Likewise, during the summer, spacings may be greater, and furrows may be shallower in order to maximize heat transfer into the air, and thus provide cooling.

In certain embodiments, the tubes 36 may be formed of a thin, flexible membrane or film. For example, polyethelene (PE) and polyvinyl chloride (PVC) are materials impervious to liquids, impervious to gases, and having reasonable lifetimes. PVC seems to tolerate solar radiation longer than does polyethylene. Nevertheless, either one may be later recycled, such as by chopping, melting, or even burning in the burner 12. Thus, the entire structure of tubes 36 may actually be recyclable, reusable, or the like.

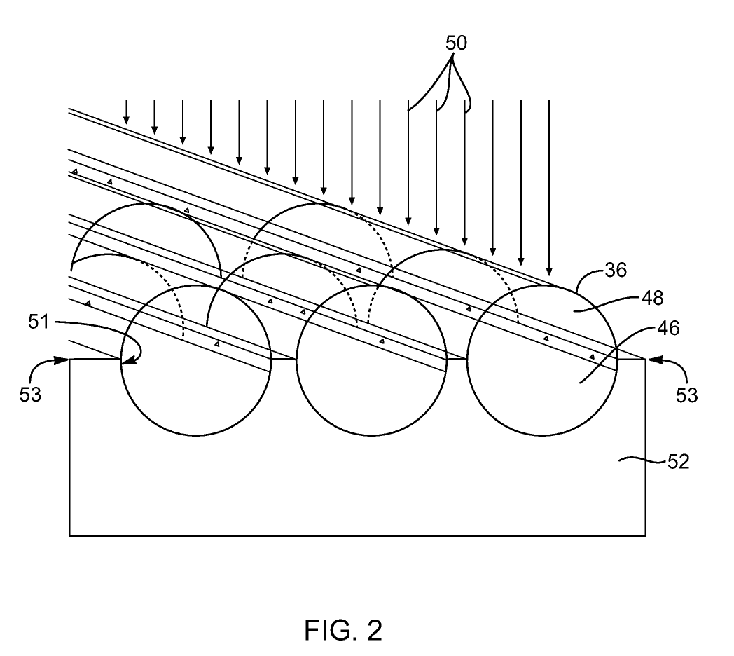

Referring to FIG. 2, while continuing to refer generally to FIGS. 1-4, each of the tubes 36 is shown with a liquid 46 or liquid region 46 containing water, algae, and some amount of the scrubbings exiting in the drain 32 from the scrubber 20. One of the benefits of an apparatus and method in accordance with the invention is that algae has the ability to use nitrogen compounds, resulting from NOx exposure to water, and certain of the VOCs.

Moreover, sulfur is often a constituent in fuels burned in the burner 12. When burned, sulfur produces primarily sulfur dioxide (SO2). In the presence of water, sulfur dioxide forms sulfurous acid (H2SO3), a weak acid. This is substantially different from sulfuric acid, commonly known for its use in batteries. Sulfuric acid is manufactured only in a very high temperature process. By contrast, sulfurous acid may be made quite readily by sufficient mixing of sulfur dioxide and water. There is even some debate as to whether sulfurous acid ever actually exists since the sulfurous acid forms the ionic constituents thereof quite readily in water.

One valuable use of sulfurous acid is to remediate alkaline and salty soils or water. Sulfurous acid tends to remove these unwanted salt from water and soils. Thus, oxides of sulfur that are often problematic in gaseous exhaust, requiring scrubbers to clean up power plant stacks, may here be used to advantage to promote additional remediation of the water being sprayed into the scrubber 20.

For example, due to the scrubber 20, the sulfur dioxide may be readily converted to sulfurous acid, which simply remains in the fluids passed out through the drain 32. In many environments, where an apparatus in accordance with the invention may be implemented, such as the western United States, substantially alkaline soils are abundant. Likewise, the water is often hard water. In some instances, the water may be recycled from other uses, and may have undesirable concentrations of salts in it.

Thus, the sulfur burned in fuels such as coal, field gas, and some oils, rather than being a problem to be remediated, becomes a benefit in remediating the water by removing from the water these undesirable constituents. Meanwhile, the release of the water, having scrubbed NOx and VOCs from stacks, and then having been relieved, in turn, of its nitrogen compounds, VOCs, and other pollutants, may be further enhanced by the sulfurous acid. Thus, the water may be released from the exit end 44 of each of the tubes 36, or from the manifold, depending on the configuration of straight or U-shaped tubes. The released water may actually have a substantially improved quality over that which entered initially to do the scrubbing, improved over the scrubbing effluent, and over a conventional, power-plant, scrubber discharge.

In FIG. 2, solar radiation 50 passes through each of the tubes 36 providing solar energy as light for the growth of algae in the liquid 46, and as heat. The heat thereof may be moderated by evaporation of water, which evaporation will also add to condensation on the inside surface of each of the tubes 36. This condensation may tend to scatter radiation and thus further distribute the sunlight to remediate or alleviate localized overheating by direct solar radiation.

In certain embodiments, the tubes 36 may actually be laid together closely enough that they are actually in physical contact. In other embodiments, as illustrated, furrows in the soil 52 may be separated such that air has access to each of the tubes 36 for cooling. Likewise, the depth of the liquid 46, and thus the depth of the furrow in the soil 52 may be selected according to heat transport considerations, as well as the design of the flows of liquids 46, the growth of algae 60, and the like.

For example, in certain embodiments, the tubes 36 may actually be deformed to become more oval. In certain embodiments, the water may spend more dwell time than the air in the tubes, since it has much less volumetric flow rate. Water may fill up a large portion of each tube 36 inside a furrow.

Meanwhile, the more width and less depth provided in each furrow 51, the more oblate or flattened the tube 36 may appear. Thus, a comparatively rapid flow of gas through a comparatively smaller but wider cross-sectional region may promote a larger flat, top surface area for algae but with a shallower depth.

Alternatively, the depths of each of the furrows 51 may be tall and narrow, to provide more contained volume, per unit of surface area exposed to the sun or solar radiation 50. Meanwhile, the proportion of each tubular cross section or the cross section of each tube 36 may be controlled by the shapes of the furrows 51. Likewise, the portion of each tube 36 placed below ground level 53 and the proportion placed thereabove may be adjusted by engineering design.

Parameters are available in the illustrated embodiment to control flows and processes. The values of ground insulating value, volume of liquid 46 (e.g. water), the surface area per unit of volume thereof, the surface area of each tube 36 exposed to the cooling ambient air, and the portion of each tube 36 exposed by contact to another tube 36 of the same temperature, are all available as control parameters. As engineered parameters they may be used to control operating conditions of the system 10.

Engineered relationships between these parameters, along with suitable heat transfer coefficients, net heat flows, net mass flows, and the like may provide precise control of the volume and velocity of gas flows 48 or vapors 48, water flows 46, and heat transfer to and from the walls of the tubes 36.

For example, in winter, where the ambient temperatures are comparatively low, with wind or snow likely, the net outflow of heat through the top of each tube 36 may be engineered by flow rates of fluids and shaping and arrangement of the array 38 of tubes 36. Likewise, during summertime, when sun heat loads are highest and ambient temperatures are warmer, the fluid flows as well as the orientation, arrangement, and shape of each tube 36 and associated furrow 51 may be arranged to maximize the rejection of heat into the environment and generally optimize the growth of algae in the liquid 46.

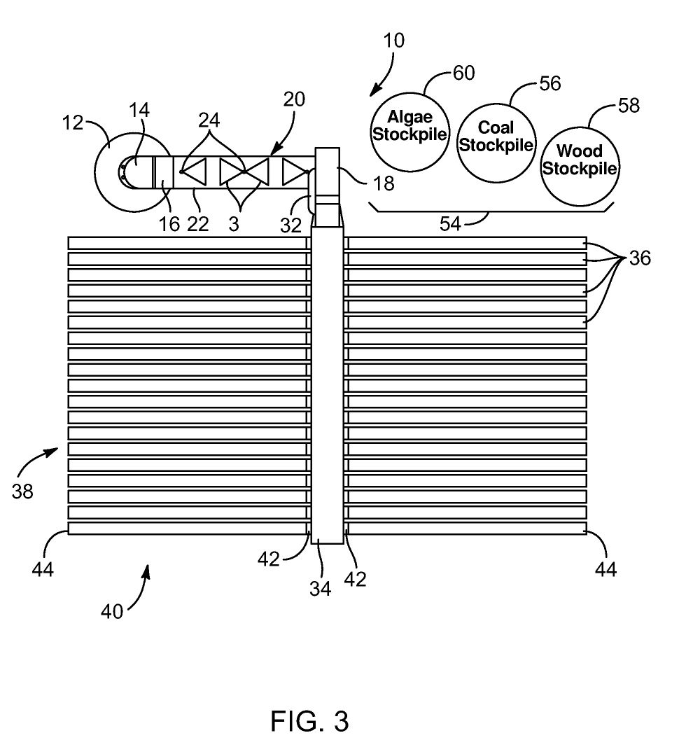

Referring to FIG. 3, while continuing to refer generally to FIGS. 1-4, the system 10 may provide for harvest of the crop grown in the liquid 46. For example, in the illustrated embodiment the burner 12 may operate using coal as a fuel Likewise, providing a suitable burner, such as a fluidized-bed combustion chamber, various types of fuels, including wood 58 may feed the burner 12.

In the illustrated embodiment, algae 60 grown in the tubes 36 may create a sufficient biomass for recycling. Just as forests produce a certain number of pounds of cellulose per acre, algae 60 may be grown at a rate of a certain number of pounds of cellulose per acre. However, in the illustrated embodiment, the tubes 30 by virtue of the maintained warmth in the growth media 46 or liquid 46, combined with the high concentrations of carbon dioxide, may grow at extremely high rates.

Wood, cellulose, and plant matter, generally, are made up of carbon. Of course, a certain amount of water also exists in any living plant organism. Nevertheless, the structure of cellulose contains substantial carbon. Therefore, in a typical environment where carbon dioxide is at very low concentrations, the rate limiting element of growth may often be the availability of carbon dioxide. In the illustrated embodiment, the enclosed environment provided by each tube 36 keeps a much higher concentration of carbon dioxide in close proximity to the algae 60 growing in the liquid 46. This relieves the restriction on growth.

Thus, the availability of a carbon supply may be removed as a growth limitation. Instead, the chemical balance of other nutrients may typically be expected to be the rate limiting factor in the growth of the algae 60 in the tubes 36.

In the illustrated embodiment of FIG. 3, the coal 56, wood 58, and algae 60 are illustrated as stock piles 54 or supplies 54 forming a stock of fuel to feed the burner 12. The algae 60 may be harvested by flushing the tubes 36 to wash all the algae out of each tube 36.

For example, sand beds providing drainage may drain away water from the algae 60. Thereafter, the algae may be sun dried, especially in the Western United States where solar energy coupled with comparatively low humidity promotes comparatively high evaporation rates. Moreover, windrowing the algae, just as hay is windrowed as part of the harvesting operation, provides turning of the algae 60, exposing it thoroughly to the low humidity air of the environment and to the sun.

The entire operation of draining and drying may take place on sand beds. Alternatively, the draining may take place on sand beds, followed by gathering up of the algae, and drying elsewhere. Any inclusion of sand in the algae simply assists and improves the fluidized bed combustion of the algae in the burner 12.

In one alternative embodiment, the algae 60 need not be recycled through the burner 12. In certain parts of the United States oil and natural gas are plentiful as fuels. In such environments, the algae 60 may be used to amend soils. For example, the algae 60 may simply be spread over and plowed into soils. The addition of the organic mass of the algae 60 captures carbon dioxide and NOx from the stack 14, and permanently removes them from circulation by putting the algae 60 into the soil to improve soil conditioning.

Much of the Western United States is desert. The soil quality in such places is often a direct cause, just as the solar loads, for that desert. Sandy soils that will not support a robust array of plant life, and soils with high alkaline content, are ubiquitous in the Western United States. Thus, recycling the algae 60 into the soils, as well as the waters discharged from the tubes 36 or manifolds 34, may provide large tracts of intensive agriculture, wherein remediated water and remediated soils are turned into productive, intensive farming sites.

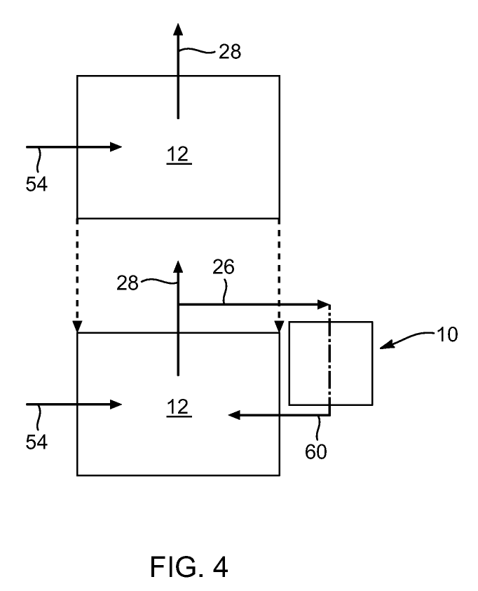

Referring to FIG. 4, while continuing to refer generally to FIGS. 1-4 a feedstock 54 or supply 54 of fuel fed into a burner 12 results in a flow 28 of effluents therefrom. However, the upper rectangle in FIG. 4 may be converted into the lower rectangle as illustrated by the dashed arrows in which the supply 54 results in a reduced requirement for fuel from outside. For example, if the algae 60 is included in the supply 54, the burner 12 has a reduced requirement or demand on the remaining supply 54.

Thus, the effluent 28 is at least partially diverted by drawing off the flow 26. The flow 26, then flows into the system 10 for remediation, returning the algae 60 as an alternative fuel. Regardless, a very high proportion of the NOx and a lesser portion of carbon dioxide from the flow 26 may be captured in the algae 60, thus providing two alternative improvements. In one embodiment, the algae 60 is recycled, by burning in the burner 12. Thus, the carbon in the flow 26 is continuing to be recycled into the flow of algae 60 and back into the burner 12. Thus, it is taken out of the circulation in the environment, and circulates only within the plant 10. Alternatively, the flow of algae 60 may be completely removed from circulation by using it to remediate soils.

In summary, as illustrated in FIGS. 1-4, some amount of the stack gases from a power plant combustion chamber, such as fluidized bed may be drawn out by a blower 18 into a scrubbing unit 20. A significant number of the constituents or products of combustion may then be drawn through several curtains 30 of spray 30 to scrub out undesirable products of combustion. Pollutants including NOx, VOC's, solid particulates, oxides of sulfur, and the like may thus be scrubbed and captured within the water to be discharged from a drain 32.

The scrubber 20, for example, may have a slightly inclined slope in order to collect liquids into the drain 32 passing to the manifold 34. The carbon dioxide-enriched combustion gases 28 of the stack 14, NOx byproducts in water, and sulfurous acid may be diverted in an amount suitable for the algae farm 40 by passing a flow 26 through the scrubber 20 and out of the stack 14. Thus, the flow 26 need only be limited by the size and availability of an algae farm 40 supportable on the surrounding soil.

The manifold 34 may include a number of closely spaced orifices to which tubes 36 may connect at their inlet ends 42. Thin walled, transparent, flexible, plastic tubing may be used for the tubes 36, reducing costs, easing construction, and relying on the surrounding soils for support in furrows formed at ground level. Tubes 36 may extend away from the manifold 34 towards their exit ends 44, or may be shaped in a U configuration wherein the exit 44 returns water to the manifold 34 or elsewhere.

The gases exhausting over the water therebelow contain an enriched level of usable nitrogen fertilizer and carbon dioxide at sufficient pressure to maintain flow from the blower, through the manifold 34, and out through each of the tubes 36. Pulsed flows, continuous flows, dams, or constrictions on the ends 44 of the tubes 36 may provide for inflation of tubes 36, movement of water, even distribution of the flow, and churning of the algae to greatly increase growth. Proper pressure differentials may support optimal distribution of gases (e.g., air, carbon dioxide, NOx, etc.) throughout all the tubes 36 as well as distribution of water and water-borne nutrients.

Transparent plastic tubes 36 provide highly effective access to available solar radiation. Meanwhile, algae growing in the liquid (e.g., water, etc.) flowing from the scrubber 20 may be held firmly in place by the weight of water therein. Yet, the tubes 36 may be largely resistant to wind damage inasmuch as the furrows are close together, and the net profile is well within a low, if not the lowest, nap-of-the-earth profile.

Water levels may be maintained slightly below ground level, thus promoting ready atmospheric cooling of the gases with less effect on the water in winter. Alternatively, when needed, higher flows of gases over the water may provide increased evaporative cooling. In general, however, the warm stack gases 26 drawn from the stack 14, flowing over the water surface may provide protection against cold weather. Meanwhile, evaporative cooling may limit the heat picked up in the tubes 36 during warm weather. Thus, near optimum temperature control for algae production may be provided by balancing heat drawn into the water from the gas flow 26 through the scrubber 20, solar radiation 50, air cooling of the tubes 36, and cooling by evaporation of vapors 48 passing through the tubes 36.

Water condensing inside the upper portions of the tubes 36 may be recovered. In certain embodiments, an additional layer of film may be placed over the tubes 36, and the tubes may vent under that film. In such an embodiment, the solar radiation 50 may be reduced, while condensation of tube vapors may occur on the under side of the film.

In an alternative embodiment, the surface of the tubes 36, or the cross sections thereof may be constrained to provide gutters that collect condensate from the inside surfaces of the upper portions of the tubes 36. After recovery, condensed water may be filtered, or otherwise treated and recycled as solar distilled water.

Because algae have access to the combustion gas products, carbon dioxide enriched gases, nitrogen compounds, churning, and the like, algae growth may be stimulated to unprecedented rates compared to open ponds. Thus, the algae may assist in permanent removal of NOx and a fraction of the carbon dioxide produced in a power plant.

Harvest may be executed by something as simple as changing the level of water in the tubes 36, to pass water and algae over the “dam” level at the exit ends 44 thereof. After the water is drained away into ditches, channels, or sand-filter basins, the algae may be dried to any desired moisture content. The stock 54 may thus be a mixture of coal, wood, algae, any two, or any single one thereof.

In a multi-fueled power plant in which algae grows as a byproduct, the remediation system amounts to solar augmentation. The solar radiation 50 provides the energy captured in the chemical bonds of the carbon structure of the biomass for algae 60. The algae 60 may become a feedstock 54 for the burner 12, thus, capturing NOx and carbon dioxide, and cycling permanently a certain portion of the carbon consumed by the burner 12.

To the extent that the tubes 36 degrade under exposure to the sun and other weather, they may be periodically replaced. Shredding, burning, or otherwise recycling the plastics of the tubes 36 may be accomplished using the burner 12 or any other suitable recycling method previously developed for such plastics.

Another advantage of a fluidized bed combustion system is avoidance of buildup of any concentration of heavy metals due to endless recycling. Limestone and other remediation systems for removing such pollutants by scavenging may be incorporated into the combustion chamber to pick up or remove such buildup.

In certain embodiments, control systems may be implemented to provide affirmative control, monitoring, both, or either one alone. For example, the constituents of gases and liquids emanating from the exit ends 44 or outlets 44 of the tubes 36 may be monitored, as well as the condition of temperatures, humidity, chemical constitution, and the like at other locations such as stack 14, scrubber 20, the drain 32, manifold 30, the algae beds in the tubes 36, and so forth.

The present invention may be embodied in other specific forms without departing from its operating principles or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method comprising:
selecting a burner combusting a fuel and discharging stack gases therefrom;
selecting a stack carrying the stack gases, comprising products of combustion, away from the burner;
connecting a scrubber conducting the stack gases therethrough, from the stack through a plurality of curtains of water spraying across the flow of stack gases in the scrubber;
providing a motive device controlling flow of the stack gases from the stack through the scrubber
removing into the water from the stack gases
a significant portion of volatile organic compounds contained therein,
substantially all the sulfur compounds contained therein,
most particulates contained therein, and
most of the heat contained therein with respect to ambient temperature,
feeding an algae crop by distributing the liquid and stack gases through an array of tubes containing growing algae; and
harvesting the algae from the array of tubes.

2. The method of claim 1, further comprising at least one of providing the burner and providing the stack.

3. The method of claim 1, further comprising controlling draft back pressure at an exit of the stack by controlling the motive device.

4. The method of claim 1, further comprising removing from the water volatile organic compounds retrieved thereinto from the stack gases.

5. The method of claim 1, further comprising converting oxides of sulfur into sulfurous acid.

6. The method of claim 1, further comprising removing salt from the water by sulfur sulfurous acid in the water.

7. The method of claim 1, further comprising converting to algae-available nitrogen compounds at least a portion of NOx retrieved from the stack gases into the water.

8. The method of claim 1, further comprising increasing the growth rate of the algae by exposing the algae to heat removed from the stack gases into the water.

9. The method of claim 1, further comprising increasing the growth rate of the algae by distributing thereto at least a portion of carbon dioxide from the stack gases.

10. The method of claim 1, further comprising removing salts from the water by acidifying the water with the oxides of sulfur absorbed from the stack gases into the water.

11. The method of claim 1, further comprising increasing the rate of growth of the algae by fertilizing the water by compounds of nitrogen derived from the NOx in the stack gases and the water sprayed into the scrubber.

12. The method of claim 1, wherein the motive device is selected from a damper, a blower, and a combination thereof.

13. The method of claim 12, further comprising controlling pressure at the outlet of the stack by controlling operation of the motive device.

14. The method of claim 13, further comprising removing from the water volatile organic compounds retrieved thereinto from the stack gases.

15. The method of claim 14, further comprising converting oxides of sulfur into sulfurous acid.

16. The method of claim 15, further comprising removing salt from the water by the sulfurous acid in the water.

17. The method of claim 16, further comprising converting to a fertilizer available to the algae at least a portion of NOx retrieved from the stack gases into the water.

18. The method of claim 18, further comprising increasing the growth rate of the algae by at least one of:
exposing the algae to heat removed from the stack gases into the water;
distributing to the algae at least a portion of carbon dioxide from the stack gases;
exposing a greater surface area of the algae to the stack gases by churning the water in which the algae is growing by pulsing the flow of stack gases above the surface of the water.

19. A method comprising:
selecting a burner combusting a fuel and discharging stack gases therefrom;
selecting a stack carrying the stack gases, comprising products of combustion, away from the burner;
the selecting a stack, wherein the stack gases include oxides of nitrogen, oxides of sulfur, and carbon dioxide;
providing a scrubber conducting the stack gases from the stack through water spraying as a plurality of curtains across the flow of stack gases in the scrubber;
providing a motive device controlling draft back pressure at an exit of the stack;
removing, by the water, at least a portion of volatile organic compounds from the stack gases;
removing, by the water, most of the oxides of sulfur from the stack gases into the water;
removing, by the water, most of the oxides of nitrogen from the stack gases into the water;
removing, by the water, most of the particulates and heat from the stack gases into the water;
providing a manifold receiving the water, as both liquid and vapor, and the stack gases;
distributing at least a portion of the water and stack gases through an array of tubes;
growing algae in the tubes;
removing salts from the water by acidifying the water with the oxides of sulfur absorbed from the stack gases into the water;
removing by the algae at least a portion of the nitrogen dissolved in the water as nitrogen compounds;
removing, by the algae, at least a portion of the carbon dioxide from the stack gases; and
harvesting the algae from the array of tubes.

20. An apparatus comprising:
a conduit connecting to conduct stack gases from a burner;
a scrubber connected to receive and conduct the stack gases away from the burner;
the scrubber further comprising a chamber receiving and conducting therethrough oxides of nitrogen, oxides of sulfur, and carbon dioxide, and water vapor as constituents of the stack gases;
the scrubber further comprising a spray system spraying a plurality of curtains, each comprising water, across the flow of stack gases in the chamber;
a motive device controlling draft back pressure at an exit of the stack;
the curtains further configured to remove from the stack gases and into the water, at least a portion of volatile organic compounds from the stack gases;
the curtains further configured to remove from the stack gases and into the water, at least most of the oxides of sulfur;
the curtains further configured to remove from the stack gases and into the water, at least most of the oxides of nitrogen from the stack gases into the water;
the curtains further configured to remove from the stack gases and into the water, at least a majority of the particulates and heat contained therein;
a manifold receiving the water, as both liquid and vapor, and the stack gases from the scrubber;
an array of tubes, transparent to pass sunlight therethrough and substantially impervious to the water and stack gases;
the manifold further provided with apertures distributing at least a portion of the water and stack gases throughout the array of tubes;
a culture of algae growing in the array of tubes;
a valving system connected to pump the at least a portion of the water through the array of tubes by pulsing the at least a portion of the stack gasses therealong in the tubes of the array of tubes;
the valving further configured to expose the algae to increased amounts of nutrients in the water by controlling a flow of the at least a portion of the stack gases through the tubes of the array of tubes effecting a churning of the algae therewithin;
the scrubber, further configured to remove salt from the water by acidifying the water with the oxides of sulfur absorbed from the stack gases into the water;
the scrubber, further arranged to increase compounds of nitrogen dissolved in the water by dissolving NOx into the water;
the array of tubes, further arranged to expose the algae to increased levels of carbon dioxide by exposing underwater portions thereof to the stack gases by the churning of the algae; and
the array of tubes, further selected to be flexible and arranged with ridges therebelow to maintain pumped portion of the water against flowing back, after being pumped, to a location of origin prior to being pumped.
